(19) United States
(12) Patent Application Publication
(10) Pub. No.: US 2019/0010800 A1
(43) Pub. Date: Jan. 10, 2019

(54) DOWNHOLE CEMENT EVALUATION USING AN ARTIFICIAL NEURAL NETWORK

(71) Applicant: Halliburton Energy Services, Inc., Houston, TX (US)

(72) Inventors: Yike Hu, Houston, TX (US); Weijun Guo, Houston, TX (US)

(21) Appl. No.: 16/066,502

(22) PCT Filed: Mar. 11, 2016
(86) PCT No.: PCT/US2016/021996

§ 371 Date: Jun. 27, 2018

(51) Int. Cl. E21B 47/00; G01V 5/12

(52) U.S. Cl. CPC E21B 47/0005; G01V 5/12

(57) ABSTRACT

Evaluation of borehole annulus cement quality is performed by an artificial neural network configured to estimate one or more cement attributes based on a radiation response of the annulus cement. A plurality of attributes indicative of quality of cement in the annulus can be estimated or derived based on gamma radiation response information (such as a gamma spectrum of the annulus cement). The artificial neural network is trained to perform the estimation by provision to the artificial neural network of training data from multiple example boreholes. The training data can include empirical data and/or simulation data.

### BACKGROUND

Natural resources such as gas, oil, and water residing in a geological formation may be recovered by drilling a wellbore into the formation. A string of pipe (e.g., casing) is run into the wellbore in order to provide structural support for the wellbore sides. The casing may be metal (e.g., steel), having a diameter smaller than the wellbore, so that an annulus is defined between the casing and the formation through which the wellbore extends.

Primary cementing may be performed whereby a cement slurry is injected into the annulus between the casing and the geological formation. The cement is permitted to set into a hard mass (i.e., a sheath) to thereby support the string of pipe within the wellbore and seal the annulus. Due to the tightly coupled nature of the formation, sheath, and casing, it may be difficult to evaluate the cured cement.

Non-invasive testing of annulus cement quality is moreover complicated by the fact that a number of different attributes pertaining to cement quality can influence a response signal elicited by non-invasive interrogation of the formation, sheath, and casing.

### BRIEF DESCRIPTION OF THE DRAWINGS

FIG. 1 is a cross-sectional diagram of a cased borehole in a geological formation, according to various example embodiments of the disclosure.

FIG. 2 is a block diagram showing a logging tool according to some example embodiments located within the example cased borehole of FIG. 1.

FIG. 3A is a block diagram of a system for automated evaluation of one or more quantitative annulus cement attributes using an artificial neural network, according to one example embodiment.

FIG. 3B is a schematic block diagram of an artificial neural network forming part of the system of FIG. 3A, according to one example embodiment.

FIG. 4 is a schematic flowchart illustrating an example method for evaluating annulus cement attributes, according to one embodiment.

FIG. 5A is an example graph showing training data used for training an artificial neural network according to an example embodiment, the training data comprising gamma response spectra for a plurality of simulated boreholes having a water column at varying radial positions within the annulus.

FIG. 5B is an example graph showing training data used for training an artificial neural network according to an example embodiment, the training data comprising gamma response spectra for a plurality of simulated boreholes in which varying percentages of the annulus is constituted by water located within cement voids.

FIG. 6A is an example gamma spectrum that may be obtained for annulus cement using a radiation logging tools such as that of FIG. 1, according to an example embodiment.

FIG. 6B is a normalized gamma spectrum based on the graph of FIG. 6A.

FIG. 7 is a diagram showing a drilling system, according to various examples of the disclosure.

FIG. 8 is a diagram showing a wireline system, according to various examples of the disclosure.

FIG. 9 is a block diagram of an example system operable to implement the activities of multiple methods, according to various examples of the disclosure.

### DETAILED DESCRIPTION

Some of the challenges noted above, as well as others, can be addressed by implementing the apparatus, systems, and methods described herein. One aspect of the disclosure provides for evaluating annulus cement quality by using an artificial neural network to estimate one or more cement attributes based on a radiation response of the annulus cement. In some embodiments, a plurality of attributes indicative of quality of cement in the annulus may be estimated or derived based on gamma radiation response information (e.g., based on a gamma spectrum of the annulus cement). The method may include obtaining the gamma radiation response information using a downhole tool configured to take formation independent gamma response measurements of the annulus cement.

The method may include training the artificial neural network to perform the estimation by providing to the artificial neural network training data from multiple example boreholes. The training data may be experimental data or empirical data in which measured gamma spectra of real boreholes are provided to the artificial neural network together with corresponding known or established cement attributes. Instead, or in addition, the training data may comprise simulation data comprising simulated gamma spectra and corresponding operator-assigned cement attributes of respective borehole models by use of which the simulated data is generated. The method may in such cases include generating simulation data by simulating gamma ray responses of multiple modeled example boreholes.

The one or more estimated cement attributes obtained as outputs from the artificial neural network to provide a quantified indication of cement quality/integrity may include cement void position, cement void amount (e.g., expressed as a volumetric percentage), materials deposited inside the cement voids, water column size, and water column position. It will be appreciated that neither the above-listed example attributes nor other cement attributes mentioned in this disclosure as being produced as artificial neural network outputs constitute an exhaustive list of annulus cement attributes that may be estimated or derived by use of the disclosed techniques. Note further that the particular cement attributes produced as outputs of the automated estimation is dependent on the particular attributes with which the artificial neural network is trained. Training of the artificial neural network can thus be seen as operator-controlled configuration of a particular artificial neural network to configure it specifically for the estimation of operator-specified cement attributes.

In many examples, a logging tool employed to obtain annulus cement gamma response data may have a radioactive source and detector with a collimator in which a detector-to-source distance and a detector collimator geometry are set to provide downhole cement evaluation that is substantially independent of geological formation properties (e.g., porosity independent, density independent).

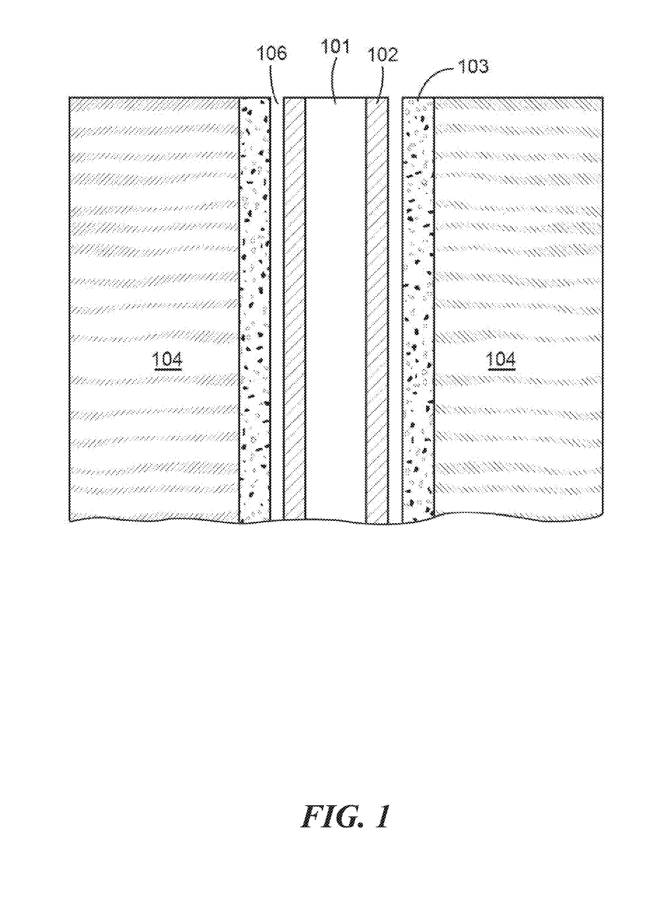

FIG. 1 is a cross-sectional diagram of a cased borehole 101 in a geological formation 104, according to various examples of the disclosure. The borehole 101 is circular-cylindrical in cross-section, with a diameter of the borehole 101 being defined by circular-cylindrical walls of the borehole 101.

The borehole 101 is lined with a casing 102 that may be of metal (e.g., steel). The casing 102 is hollow circular-cylindrical and extends substantially co-axially along the borehole 101 with a radial spacing between the outer diameter of the casing 102 and the formation 104. The circumferentially extending radial spacing between the casing 102 in the formation 104 (i.e., being annular in cross-section) defines an annulus which is to be filled with cement 103. The cement 103 is injected into the borehole 101 such that, after it reaches the bottom of the borehole, it returns upward in the annulus region between the casing 102 and the formation 104. Thus, the cement 103 stabilizes the casing 102 within the borehole 101.

Due to possible imperfections introduced into the cement 103 during construction and/or subsequent wear damage caused by use of the borehole, it is often desirable to perform non-destructive testing of the cement 103. In some cases, for example, a gap 106 may be present between the casing 102 and the cement 103. Such a gap 106 represents a non-cement space within the annulus and is thus referred to herein as a cement void of a void within the annulus cement 103. Note that the radial position of such a substantially annular gap 106 may be different in other boreholes. Note also that the annulus cement 103 may include macroscopic imperfections consisting of voids that are not axially symmetrical about the longitudinal axis of the borehole 101, for example having substantially random axial and/or radial positions and being of substantially random axial and/or radial extent.

Such voids may be substantially air-filled, or may be filled with a variety of materials. The particular material composition of the voids are relevant to integrity of the annulus cement 103. Cement voids may often be water-filled. In instances where the annulus cement 103 has a continuous actually extending void (e.g., such as gap 106 of FIG. 1), the annulus cement 103 may be described as including a water column.

Using a logging tool having a radioactive source, detector and detector collimator in the borehole, quantitative estimation of cement properties may be derived using an artificial neural network, quantifying cement quality attributes indicating, for example, the size and/or positions of possible gaps or voids in the cement 103. In this example embodiment, the annulus cement 103 is subjected to formation-independent radioactive evaluation based on radiation log data obtained using a downhole tool 210 as described and illustrated in PCT/US2015/026800 filed on Apr. 21, 2015 and titled “Formation Independent Cement Evaluation with Active Gamma Ray Detection”.

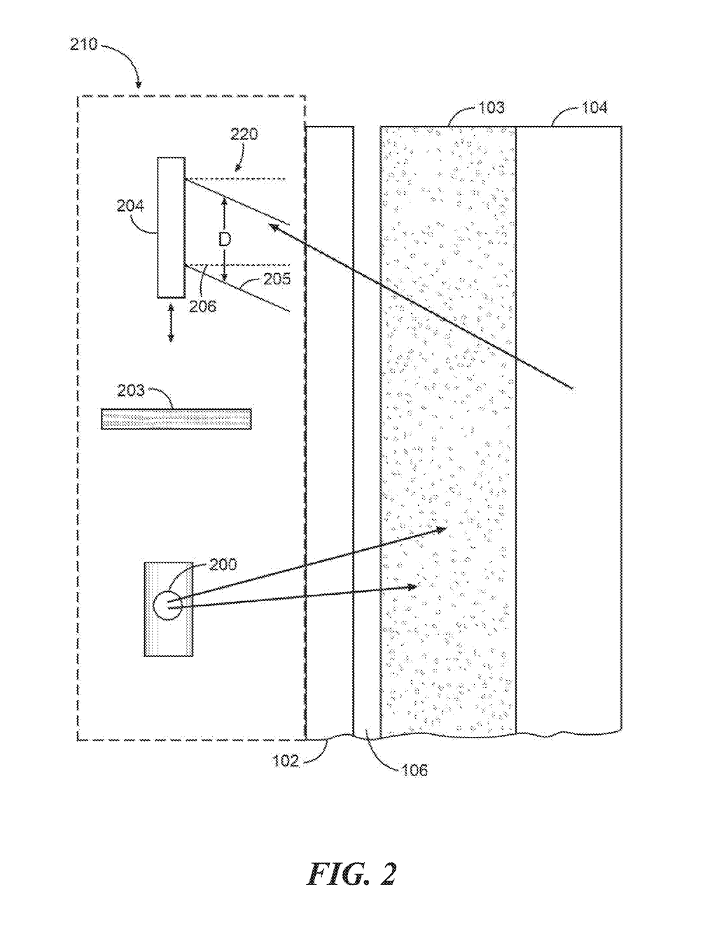

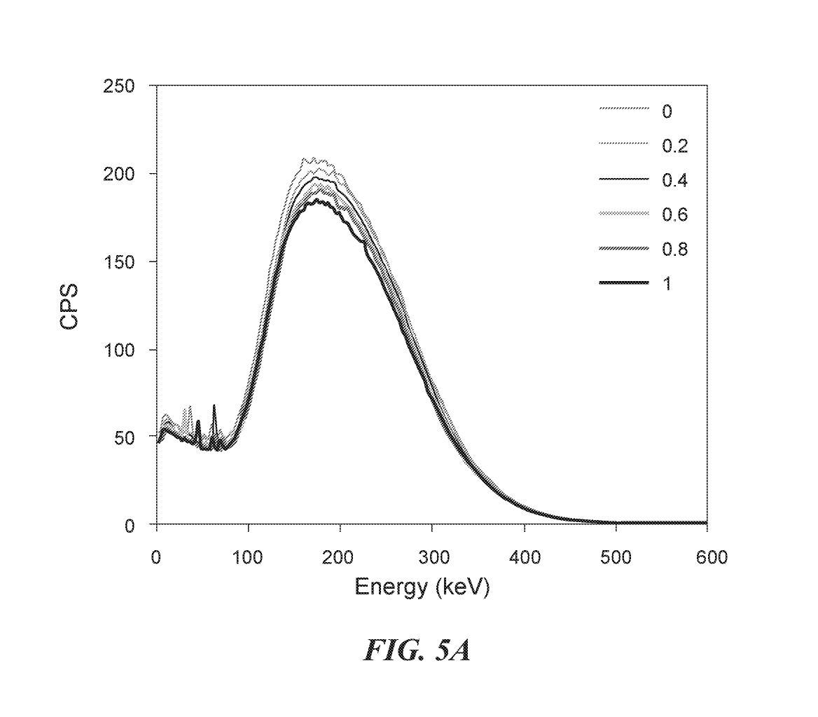

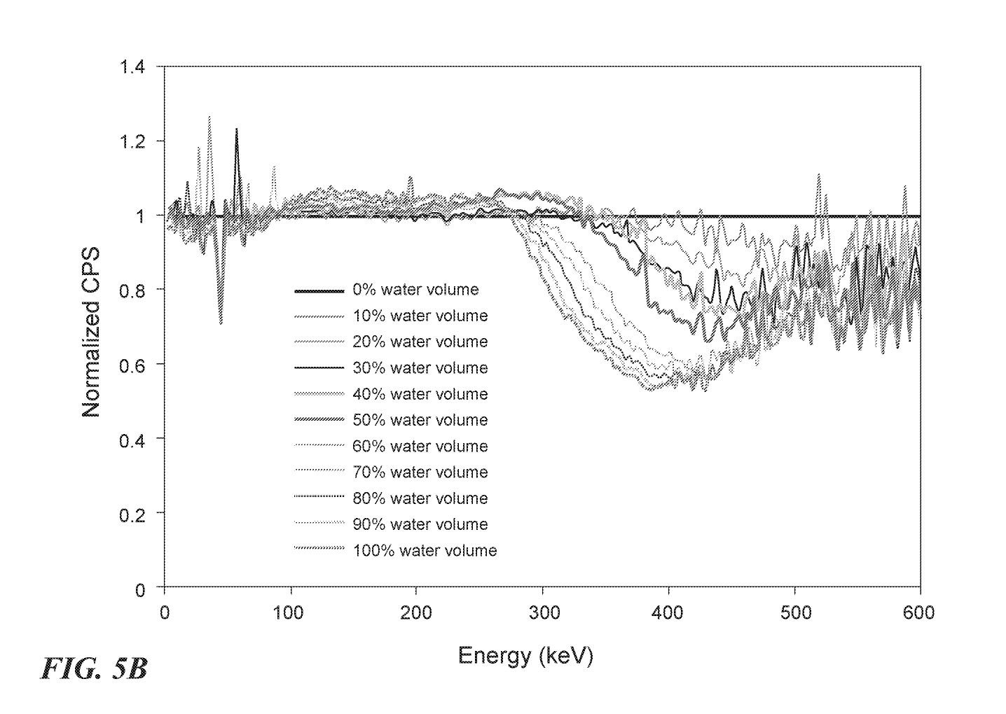

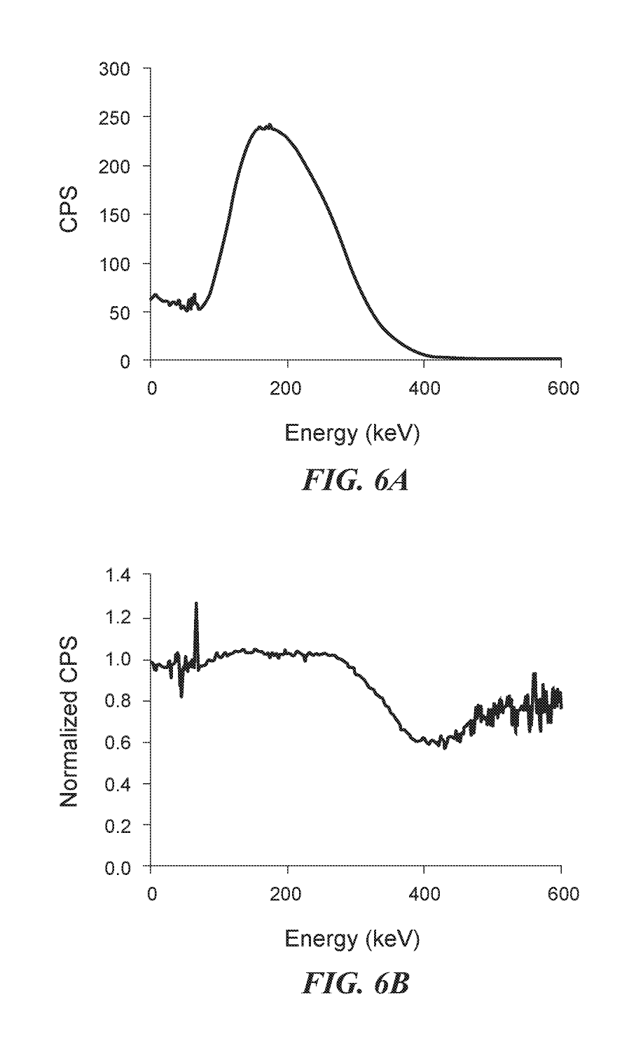

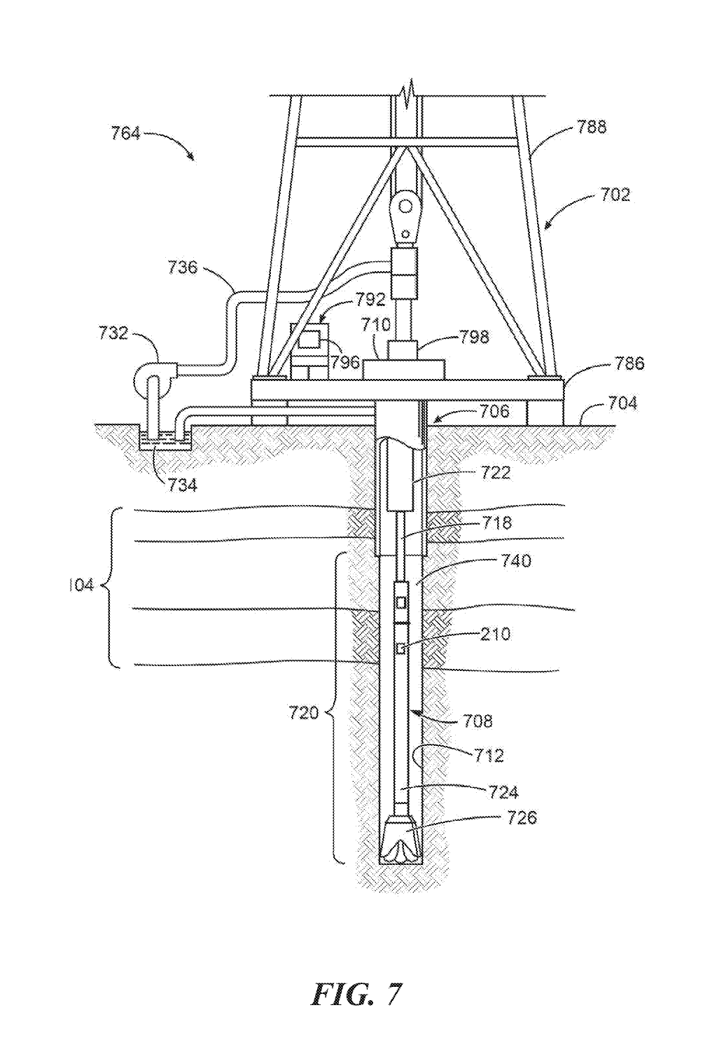

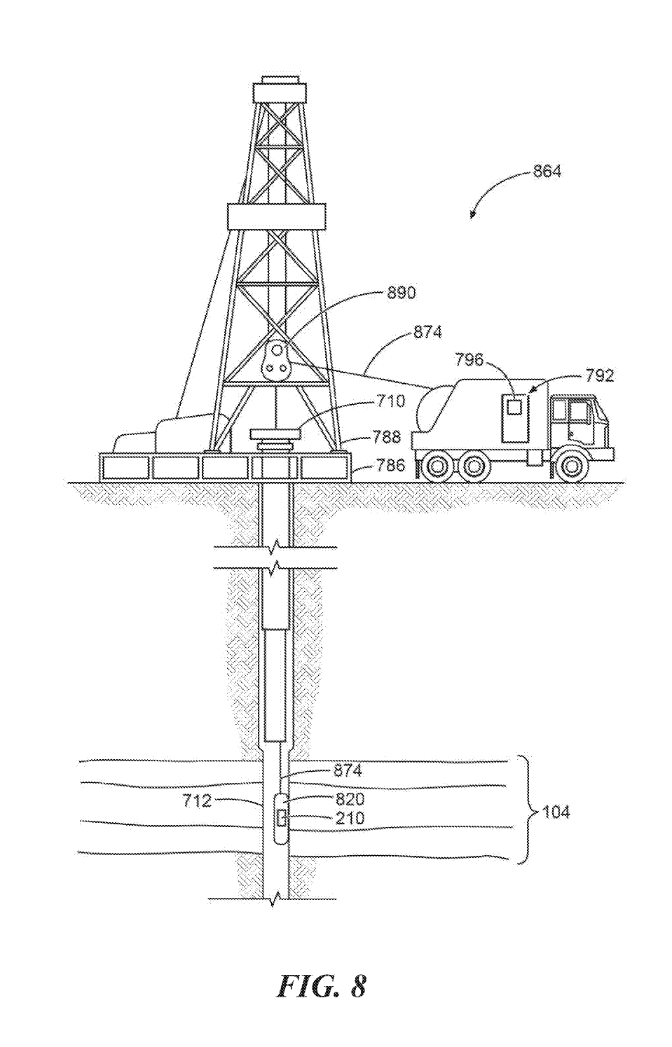

FIG. 2 is a block diagram showing one example embodiment of such a radioactive source and detector logging tool 210, the tool 210 being located within the central bore of the casing 102 of the example borehole 101. The logging tool 210 uses photons transmitted from a radioactive source 200 (e.g., chemical gamma) to penetrate the material of the casing 102 and cement 103, with reflections back to a detector 204 to generate gamma spectra (e.g., FIGS. 5 and 6) associated with the cement 103 and possible voids behind the casing 102 and/or inside the cement 103. The logging tool 210 may be located in a drill string tool housing to be used during a logging while drilling (LWD)/measurement while drilling (MWD) operation (see FIG. 7) or a wireline tool housing to be used during a wireline logging operation (see FIG. 8).

The logging tool 210 includes the radioactive source 200 for generating the photon beam. The radioactive source 200 may comprise any monochromatic high energy photon source, including gamma ray source (e.g., caesium-137). Heat generated by source operation may be dissipated through cooling fluid (e.g., air, water, oil). The photons in the gamma ray beam interact with the cement 103, which scatters the photons back through the gap material 106 (if any) and the casing 102. The logging tool 210 further comprises one or more gamma ray detectors 204 to detect photons reflected by the cement.

A radiation shield 203 is located between the radioactive source 200 and the detector 204. The shield 203 blocks photons from traveling directly from the source 200 to the detector 204 without passing through the cement 103. The radiation shield 203 may be any photon blocking material (e.g., tungsten, lead) appropriate for blocking high energy photons. The front of the detector 204 is shielded with metal having a relatively high atomic number, such as tungsten, to block photons coming from scattering other than the cement 103. A detector collimator 220 may be cut into the detector shielding to allow the photons scattered behind the casing to pass through. The size (e.g., diameter) D of the detector collimator 220, its relative position to a detector crystal and its angle (if any) relative to the source 200 may determine the amount of gamma ray (i.e., photons) detected by the detector 204. A gamma spectrum measured based on such irradiation may be presented as a photon detection rate (e.g., counts per second) at different energies, as represented, for example, by the graphs of FIGS. 5 and 6.

As discussed subsequently in greater detail, one example of a detector collimator 205 may be angled (relative to a longitudinal axis of the borehole) more towards the source 200 than towards the formation. Another example of a detector collimator 206 may be angled more towards the formation 104 than towards the source 200. Various examples of the detector collimator 220 may also have various sizes D in order to detect desired energy spectra. In order to provide a more desirable formation independence of the detected energy spectra, an energy range may be increased in response to the detector collimator being angled more towards the source. In another example, the energy range may be increased in response to decreasing the diameter of the detector collimator. In either of these examples, the increased energy range may be in the 300 keV to 500 keV range. As used herein, a detector collimator 205 that is angled more towards the formation comprises having the input of the detector collimator 205 having an angle of approximately 90° with a longitudinal axis of the logging tool. A detector collimator 205 that is angled more towards the source 200 comprises an input of the detector collimator 205 having an included angle of substantially less than 90° with the longitudinal axis of the logging tool.

The distance between the detector 204 and the source 200 may in some embodiments be adjusted, in addition to adjusting the collimator angle and/or the collimator diameter, to detect and evaluate gamma ray energy spectra within an energy range (e.g., <600 keV). The tool 210 may be configured such that operative portions of the energy spectra are independent of the formation properties (e.g. porosity, density). In the example embodiments that follows, the example methods include adjusting the tool parameters or designing/selecting the tool parameters such as to increase spectrum sensitivity to cement quality, and to decrease spectrum sensitivity to geological formation properties. These tool parameters include detector-to-source spacing, detector collimator size, and detector collimator angle.

During a logging operation, the logging tool 210 may be placed against the casing 102 in the borehole 101 in order to reduce or eliminate any gaps between the tool 210 and the casing 102 that might alter spectral measurements. Photons entering the cement 130 from the source 200 may be reflected back through interaction with cement 103 at certain depths. As the logging tool rotates in the azimuthal direction in the wellbore, the gamma ray interacts with the cement encircling the wellbore 101 at the same depth so that the entire diameter of the cement is investigated as the tool 210 moves through the wellbore 101

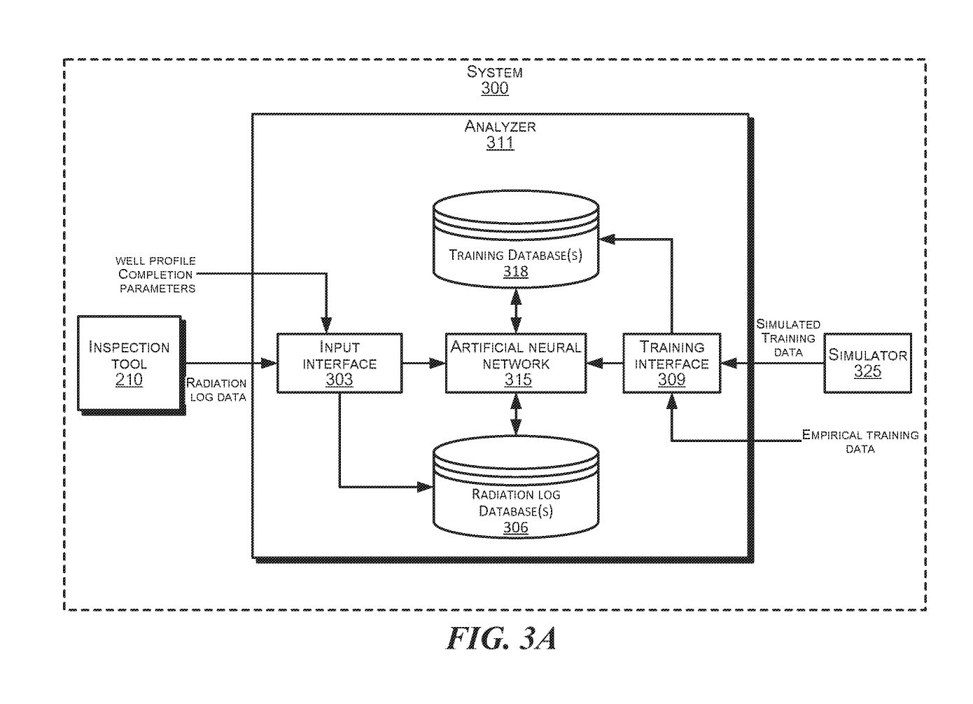

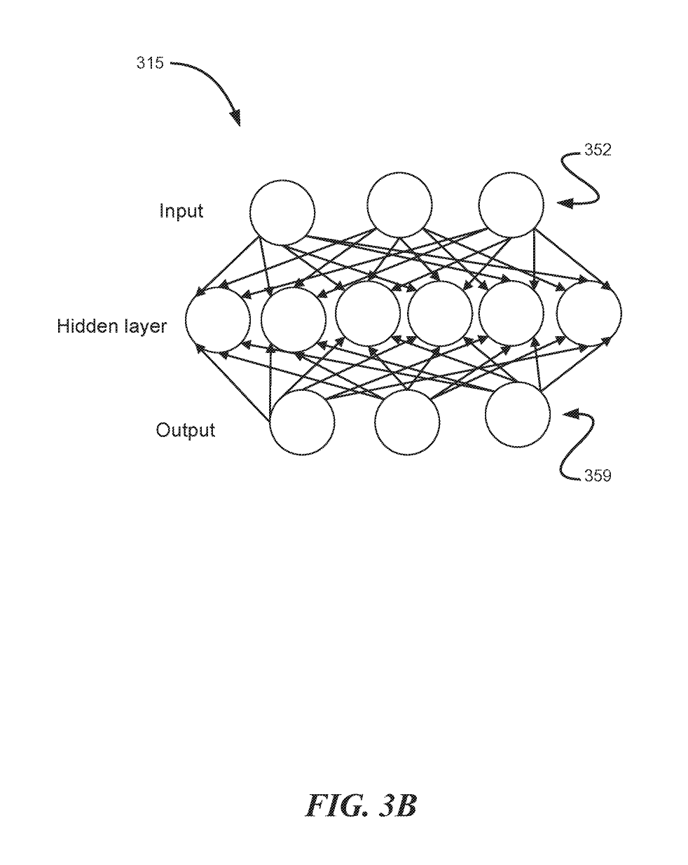

FIG. 3A shows an example embodiment of a system 300 for evaluating annulus cement properties. The system 300 includes an analyzer 311 that has an input interface 303 configured for receiving gamma spectrum log data from the logging tool 210. The input interface 303 is also configured to receive operator input with respect to at least some known properties of the borehole 101 under investigation, also referred to herein as well profile completion parameters. A radiation log database 306 provides memory in which is stored the gamma spectrum log data obtained via the tool 210.

The system 300 further comprises a training interface 309 configured to receive training data for training an analyzer 311 comprising an artificial neural network 315. The training interface 309 is configured to store training data in a training database 318 and to supply the inputted training data to the artificial neural network 315 in order to train the artificial neural network 315 for automated cement quality evaluation based on gamma spectrum information collected by the tool 210. The analyzer 311 is further coupled to an output mechanism 321 to output estimated cement attribute values to an operator, e.g., via a display screen.

FIG. 3B shows a schematic diagram of the example artificial neural network 315. The artificial neural network 315 comprises a system of interconnected nodes configured to correlate input and output information. Each of the nodes of the artificial neural network 315 comprises a processing element configured to combine a set of input data to produce a single numeric output. The specifics of the output signal of the notice given by a nonlinear function, which may in some instances be based on a weighted sum of the input signals received by the node. As illustrated schematically in FIG. 3B, the artificial neural network 315 comprises a plurality of nodes that represent input data values and serve as an input layer 352, and a plurality of nodes that represent output data values and that serve as an output layer 359. The input layer 352 and the output layer 359 are connected by one or more layers of interconnected nodes, represented in FIG. 3B as a single representative hidden layer.

The network architecture of the artificial neural network 315 and respective nonlinear expressions of its nodes can be modified using a supervised training procedure in order to correlate input data values with output data values. Once the artificial neural network 315 has thus been trained for coordinating specified input with specified output, they trained artificial neural network 315 effectively serves as a nonlinear map for predicting the relevant outputs based on corresponding input data.

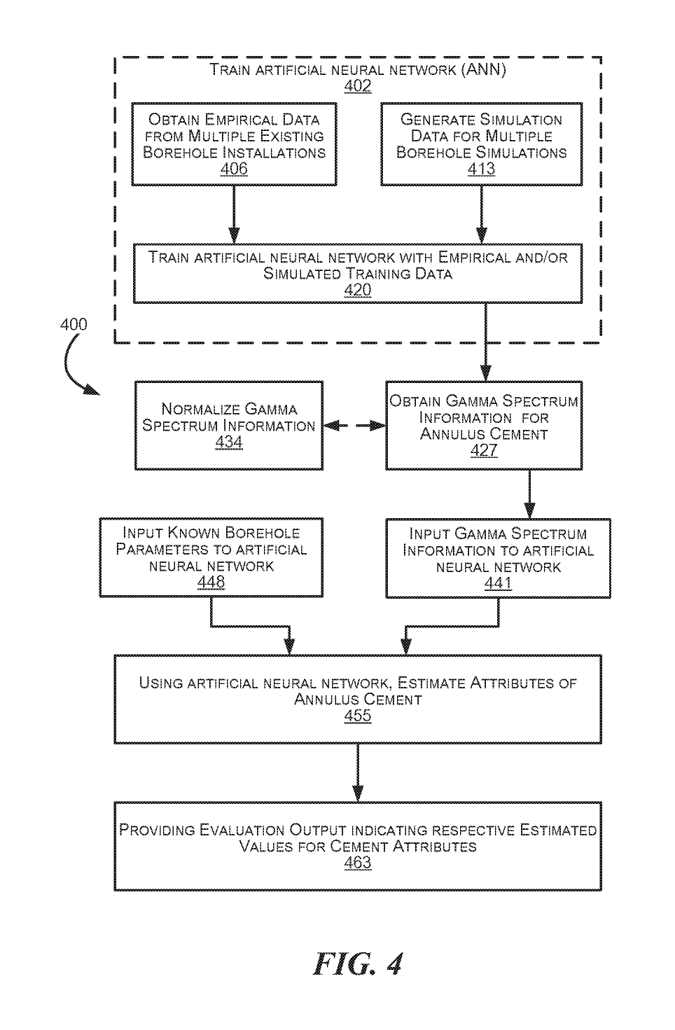

The system 300 in this example embodiment further includes a simulator 325 configured to enable an operator to construct different modeled boreholes having different borehole parameters, and to run automated simulations of such modeled boreholes to generate respective corresponding gamma spectra. Examples gamma spectra produced in this manner will be discussed below with reference to FIG. 4.

The functionalities, features, and configurations of the various components of the system 300 will now be described with reference to an example method 400 (illustrated schematically by the flowchart of FIG. 4) for automated cement evaluation according to one embodiment.

The method 400 in this example commences with a training operation, at block 402, in which the artificial neural network 315 is trained by supplying to it, at block 420, training data pertaining to multiple example boreholes. The training data comprises, for each example borehole, gamma spectrum information and corresponding known values for various cement attributes of that example borehole. By consumption and processing of the training data, the artificial neural network 315 forms complex correlations between gamma spectrum features and corresponding cement attribute values. Such training of the artificial neural network 315 thus specifically configures the artificial neural network 315 for estimation of the particular cement attributes provided to it as part of the training data.

Note that the training data in this example includes not only cement attributes (such as cement void or gap size and/or position, material composition of cement void contents, water column size, water column position, and the like) but also includes well completion profile parameters that indicate the physical configuration and material properties of the relevant well. The well completion profile parameters may include geometry profile parameters (such as, for example, how many layers of casing are present, casing thickness, casing diameter, and borehole diameter) and elemental composition (such as casing specific weight and/or other material properties, cement density, and cement composition).

The training operation (at 402) thus in this example embodiment comprises obtaining, at operation 406, experimental or empirical data from multiple real-world borehole installations to serve as example boreholes for training the artificial neural network 315. In these example boreholes, the cement attributes that are eventually to be estimated by use of the artificial neural network 315 are known, and these cement attribute values (e.g., established void size, position, and content composition) are supplied to the artificial neural network 315 together with corresponding gamma spectra measured in situ.

The method 400 and this example embodiment also includes, at block 413, generating simulation data based on respective borehole simulations that are to serve as example boreholes for training the artificial neural network 315. Each such borehole simulation comprises modeling of a borehole having operator-selected well completion profile parameters and cement attributes, and then executing an automated simulation that generates simulated gamma spectrum information for the modeled borehole. In this example, the generation of the simulation data may comprise generating, spectra information for at least one set of example boreholes based on varying a single borehole parameter (e.g., varying a single cement attribute of the modeled borehole) between different example boreholes in the set.

FIG. 5A shows a set of simulated gamma spectra thus generated for a corresponding set of example simulated boreholes in which the cement attribute of water column position is varied between the different simulations of the set. Note that all other well completion profile parameters and cement attributes have fixed values for all of the simulations of the set, with only the value for the water column position changing from one borehole simulation to the next. In this example, the water column thickness (i.e., the radial extent of the water column) is selected to be 20% of the annulus thickness. In this example, six different borehole simulations are performed to derive the set of six different gamma spectra represented on the graph of FIG. 5A. Here, the value of the water column position is varied stepwise by 20%, so that the water column position varies from being contiguous with the outer diameter of the casing 102 to being contiguous with the formation 104. It will be appreciated that each distinct spectrum on the graph of FIG. 5A is representative of a different example modeled borehole.

FIG. 5B shows another set of simulated gamma spectrum information generated for another set of example boreholes to serve as training data for the artificial neural network 315. To illustrate the difference in the gamma ray spectrum induced by the different water volumes, the curves shown in FIG. 5B are simulated spectra divided by a simulated spectrum corresponding to 0% water volume. In the example simulated training data of FIG. 5B, the variable parameter that is change from one simulation to the next is selected to be the size or extent of a water column inside the annulus cement 103. The water column size/amount is stepwise increased in 10% increments from 0% water volume to 100% water volume. Again, or other borehole parameters and cement attributes are kept at fixed values for the respective simulations, with only the water column size differing from one simulation to the next. In this example, the simulated water column is assumed to be axially symmetric and radially located contiguous with the outer diameter of the casing 102.

Note, however, that the respective gamma spectra of FIG. 5B is normalized, thereby amplifying differences between the different spectra. Here, the gamma spectra are normalized to the spectrum for the 0% water volume (i.e., in which the annulus cement 103 has no voids). For this reason, 0% water volume gamma spectrum information is represented on the graph of FIG. 5B by a horizontal line having a normalized counts per second value of 1. It will be appreciated that each of the different sets of simulated training data may be thus normalized. As is the case in the example of FIG. 5B, normalization made in each such set be done with reference to the simulated spectrum for a modeled borehole having no imperfections. In this example embodiment, all the example gamma spectrum information supplied to the artificial neural network 315 in the training operation may be in normalized format, and gamma spectrum log data obtained from the borehole 101 to be investigated may likewise be normalized (e.g., at operation 434) before or during input thereof to the artificial neural network 315 for automated cement attribute estimation.

As can be seen from the example graphs of FIG. 5A and FIG. 5B, changes in the relevant annulus cement attributes (in these example embodiments, water column position and water volume) result in corresponding changes to the respective gamma spectra. The artificial neural network 315 is thus trained to recognize such spectrum patent changes, thereby configuring it to predict the relevant cement attributes based on an input spectrum. Note that this example discusses training the artificial neural network with only two sets of simulated training data, but that different gamma spectrum sets, generated using a different respective variable parameter, can instead or in addition be used for training the artificial neural network 315.

Returning now to FIG. 4, the method 400 further comprises, at operation 427, obtaining gamma spectrum information for the annulus cement 103 of the borehole 101 under investigation. This comprises, as discussed with reference to FIG. 2, using the radiation source 200 carried by the downhole tool 210 to irradiate the annulus cement 103 with gamma radiation, and measuring the response with the detector 204.

FIG. 6A shows an example gamma spectrum that may be obtained by measurement of a gamma response of the annulus cement 103 in accordance with an example embodiment. In this example, the gamma spectrum of FIG. 6A is normalized, at operation 434 (FIG. 4), to obtain the example normalized gamma spectrum of FIG. 6B.

Returning again to the method 400 of FIG. 4, the radiation log data (in this example embodiment to the normalized gamma spectrum information of FIG. 6B) is fed to the artificial neural network 315 as input for estimation of a specified cement attribute. In this example embodiment of the cement attribute to be estimated by use of the artificial neural network 315 is the water volume within the annulus cement 103, expressed as a volumetric percentage. In addition to the measured gamma spectrum information, additional inputs to the artificial neural network 315 for performing the automated cement evaluation includes, at operation 448, inputting known borehole parameters for the borehole 101 under investigation. As mentioned before, these known parameters provided to the artificial neural network 315 includes in this example includes both (a) well completion geometry parameters that specify the dimensions and constituent components of the cased borehole 101, as well as (b) elemental composition parameters specifying known material properties of the casing 102 in the annulus cement 103. In other embodiments, in which the radiation log data gathered for the annulus cement 103 is not formation independent, the known borehole parameters supplied to the artificial neural network 315, at operation 448, may include formation properties.

At operation 445, the artificial neural network 315 estimates one or more specified cement attributes (in this example, water volume) based on the well completion profile parameters and the gamma spectrum information obtained downhole. At operation 463, the artificial neural network 315 provides evaluation output that indicates respective estimated values for each requested cement attribute. In this example embodiment, the artificial neural network 315 estimated, based on the normalized gamma spectrum of FIG. 6B, that the corresponding annulus cement 103 has a water volume of about 36%. Note that this value indicates the percentage of the annulus (i.e., the volume extending radially between the casing 102 and the formation) that is constituted by water occupying one or more voids within the annulus, and that such water need not necessarily be encapsulated wholly within the cured cement occupying the annulus. At least some of the voids may, for example, be bordered on at least one side thereof by the casing 102 or by the borehole.

It is a benefit of the disclosed techniques and that it permits for effective and comparatively speedy evaluation of cement attributes based on radiation log data. In some instances, cement evaluation by the artificial neural network 315 may be sufficiently expeditious to allow substantially real-time cement evaluation.

The disclosed techniques moreover in some licenses provide not only a binary indication as to whether or not, for example, voids are present in the annular cement 103, or whether the annulus cement 103 has acceptable or non-acceptable integrity. Instead, the disclosed techniques and systems provide for quantification of at least some cement attributes, thereby providing superior cement evaluation functionalities as compared to existing machines and systems.

FIG. 7 is a diagram showing a drilling system 764, according to various examples of the disclosure. The system 764 includes a drilling rig 702 located at the surface 704 of a well 706. The drilling rig 702 may provide support for a drillstring 708. The drillstring 708 may operate to penetrate the rotary table 710 for drilling the borehole 712 through the subsurface formations 104. The drillstring 708 may include a drill pipe 718 and a bottom hole assembly (BHA) 720 (e.g., drill string), perhaps located at the lower portion of the drill pipe 718.

The BHA 720 may include drill collars 722, a down hole tool 724 including the logging tool 210, and a drill bit 726. The drill bit 726 may operate to create the borehole 712 by penetrating the surface 704 and the subsurface formations 104. The downhole tool 724 may comprise any of a number of different types of tools besides the logging tool 210. The logging tool 210 may be used in MWD/LWD operations within a borehole 712 that has already been cased with casing and cement. Using the logging tool 210 during the MWD/LWD operations may provide data to the surface (e.g., hardwired, telemetry) on already cased and cemented portions of the borehole 712 as other portions of the borehole 712 are being drilled.

During drilling operations within the cased borehole 712, the drillstring 708 (perhaps including the drill pipe 718 and the BHA 720) may be rotated by the rotary table 710. Although not shown, in addition to or alternatively, the BHA 720 may also be rotated by a motor (e.g., a mud motor) that is located down hole. The drill collars 722 may be used to add weight to the drill bit 726. The drill collars 722 may also operate to stiffen the bottom hole assembly 720, allowing the bottom hole assembly 720 to transfer the added weight to the drill bit 726, and in turn, to assist the drill bit 726 in penetrating the surface 704 and subsurface formations 714.

During drilling operations within the cased borehole 712, a mud pump 732 may pump drilling fluid (sometimes known by those of ordinary skill in the art as “drilling mud”) from a mud pit 734 through a hose 736 into the drill pipe 718 and down to the drill bit 726. The drilling fluid can flow out from the drill bit 726 and be returned to the surface 704 through an annular area 740 between the drill pipe 718 and the sides of the borehole 712. The drilling fluid may then be returned to the mud pit 734, where such fluid is filtered. In some examples, the drilling fluid can be used to cool the drill bit 726, as well as to provide lubrication for the drill bit 726 during drilling operations. Additionally, the drilling fluid may be used to remove subsurface formation cuttings created by operating the drill bit 726.

A workstation 792 including a controller 796 may include modules comprising hardware circuitry, a processor, and/or memory circuits that may store software program modules and objects, and/or firmware, and combinations thereof that are configured to execute the method of FIG. 4. For example, the workstation 792 with controller 796 may be configured to digitize count rates of different energy into multichannel spectra and generate formation independent energy spectra and use the spectra shape and amplitude to determine cement quality, according to the methods described previously. The controller 796 may be configured to determine a photon count rate, an amplitude, and a shape of the energy spectra in order to determine the quality of the cement.

Thus, in various examples, components of a system operable to conduct high energy photon detection, as described herein or in a similar manner, can be realized in combinations of hardware and/or processor executed software. These implementations can include a machine-readable storage device having machine-executable instructions, such as a computer-readable storage device having computer-executable instructions. Further, a computer-readable storage device may be a physical device that stores data represented by a physical structure within the device. Such a physical device is a non-transitory device. Examples of machine-readable storage devices can include, but are not limited to, read only memory (ROM), random access memory (RAM), a magnetic disk storage device, an optical storage device, a flash memory, and other electronic, magnetic, and/or optical memory devices.

FIG. 8 is a diagram showing a wireline system 864, according to various examples of the disclosure. The system 864 may comprise a wireline logging tool body 820, as part of a wireline logging operation in a cased and cemented borehole 712, that includes the logging tool 210 as described previously.

A drilling platform 786 equipped with a derrick 788 that supports a hoist 890 can be seen. Drilling oil and gas wells is commonly carried out using a string of drill pipes connected together so as to form a drillstring that is lowered through a rotary table 710 into the cased borehole 712. Here it is assumed that the drillstring has been temporarily removed from the borehole 712 to allow the wireline logging tool body 820, such as a probe or sonde with the logging tool 210, to be lowered by wireline or logging cable 874 (e.g., slickline cable) into the borehole 712. Typically, the wireline logging tool body 820 is lowered to the bottom of the region of interest and subsequently pulled upward at a substantially constant speed. In an embodiment, the logging tool 210 is immediately adjacent to the wall of the borehole 712.

During the upward trip, at a series of depths, various instruments may be used to perform quality measurements on the casing and cement lining of the borehole 712, as described previously. The wireline data may be communicated to a surface logging facility (e.g., workstation 792) for processing, analysis, and/or storage. The logging facility 792 may be provided with electronic equipment for various types of signal processing as described previously. The workstation 792 may have a controller 796 that is coupled to the logging tool 210 through the wireline 874 or telemetry in order to receive data from the logging tool regarding the detected photons and generate the energy spectra indicative of the cement quality.

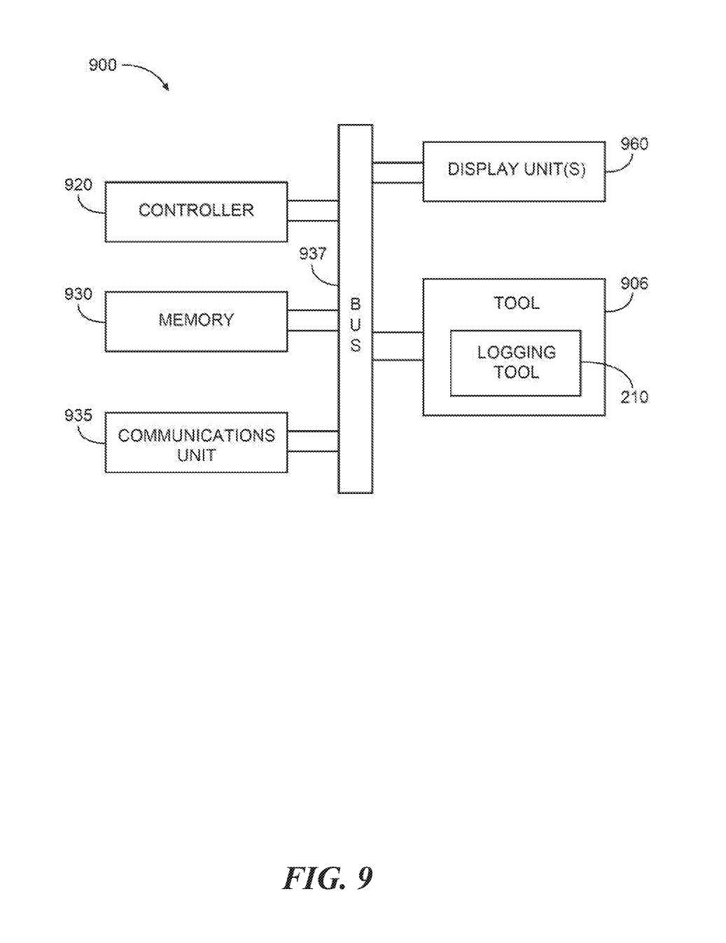

FIG. 9 is a block diagram of an example system 900 operable to implement the activities of multiple methods, according to various examples of the disclosure. The system 900 may include a tool housing 906 having the logging tool 210 such as that illustrated in FIG. 2. The system 900 may be configured to operate in accordance with the teachings herein to perform formation independent cement evaluation measurements in order to determine the quality of cement between the casing and the formation. The system 900 of FIG. 9 may be implemented as shown in FIGS. 7 and 8 with reference to the workstation 792 and controller 796.

The system 900 may include a controller 920, a memory 930, and a communications unit 935. The memory 930 may be structured to include a database. The controller 920, the memory 930, and the communications unit 935 may be arranged to operate as a processing unit to control operation of the logging tool 210 and execute any methods disclosed herein. The processing unit may be configured to digitize detected photon count rates to generate multichannel energy spectra having an amplitude and shape over an energy range that is a result of the change in quality of cement and, thus, independent of the formation.

The communications unit 935 may include downhole communications for appropriately located sensors in a wellbore. Such downhole communications can include a telemetry system. The communications unit 935 may use combinations of wired communication technologies and wireless technologies at frequencies that do not interfere with on-going measurements.

The system 900 may also include a bus 937, where the bus 937 provides electrical conductivity among the components of the system 900. The bus 937 can include an address bus, a data bus, and a control bus, each independently configured or in an integrated format. The bus 937 may be realized using a number of different communication mediums that allows for the distribution of components of the system 900. The bus 937 may include a network. Use of the bus 937 may be regulated by the controller 920.

The system 900 may include display unit(s) 960 as a distributed component on the surface of a wellbore, which may be used with instructions stored in the memory 930 to implement a user interface to monitor the operation of the tool 906 or components distributed within the system 900. The user interface may be used to input parameter values for thresholds such that the system 900 can operate autonomously substantially without user intervention in a variety of applications. The user interface may also provide for manual override and change of control of the system 900 to a user. Such a user interface may be operated in conjunction with the communications unit 935 and the bus 937.

It will be appreciated that the above-described example embodiments of non-exhaustive, and that there are many embodiments that fall within the scope of the disclosure without having been specifically described herein. The following numbered examples are illustrative embodiments in accordance with various aspects of the present disclosure, at least some of which are exemplified by the foregoing description of a detailed example embodiment.

1. A method may comprise:
using a radiation source carried by a downhole tool positioned within a borehole extending through a formation, causing gamma ray irradiation of an annulus that contains set cement and that is located between the formation and a casing lining the borehole;
measuring a gamma ray response resulting from the gamma ray irradiation of the annulus by use of a detector carried by the downhole tool, thereby to obtain radiation log data;
in an automated operation that is based at least in part on the radiation log data and that is performed using an artificial neural network configured therefor, estimating one or more cement attributes indicative of quality of the annulus cement; and
providing an evaluation output indicating respective estimated values for the one or more cement attributes.

2. The method of example 1, in which the radiation log data includes gamma spectrum information of the annulus cement.

3. The method of example 1 or 2, further including the prior operation of training the artificial neural network by feeding to the artificial neural network training data pertaining to multiple example boreholes.

4. The method of example 3, in which the training data for each example borehole includes respective gamma spectrum information and respective known values for the corresponding one or more cement attributes.

5. The method of example 3 or 4, in which the train data includes experimental and/or empirical data obtained from respective borehole installations.

6. The method of any one of example 3-5, in which the training data includes simulation data obtained based on respective borehole simulations.

7. The method of example 7, further including the prior operation of generating the simulation data for a set of example boreholes.

8. The method of example 7, in which the generating of the simulation data for the set of example boreholes includes:

(a) selecting from a set of borehole parameters a variable parameter whose value is to vary between different example boreholes in the set;
(b) for each example borehole in the set, assigning a different respective value for the variable parameter;
(c) fixing across the set of example boreholes common respective values for a remainder of the set of borehole parameters, so that the different example boreholes in the set differ only with respect to the variable parameter;
(d) and deriving separate simulated gamma spectrum information for each example borehole in the set.
In some embodiments, the simulation data may include gamma spectrum information for a group of different sets of example boreholes generated based on varying a single one of the set of borehole parameters, with a different borehole parameter selected as the variable parameter in generating the gamma spectrum information for the different sets.

9. The method of any one of examples 1-8, further including providing as input to the artificial neural network one or more known parameters of the borehole.

10. The method of example 9, wherein the one or more known parameters of the borehole includes a cement density of the annulus cement.

11. The method of example 9 or example 10, wherein the one or more known parameters of the borehole include at least one geometry profile parameter indicating a physical configuration of at least one borehole. For example, the at least one geometry profile parameter may comprise parameters indicating physical configuration of the casing and/or the annulus.

12. The method of any one of examples 9-11, wherein the one or more known parameters of the borehole include an elemental composition parameter pertaining to composition of the annulus cement.

13. The method of any one of examples 1-12, wherein the one or more cement attributes estimated by the artificial neural network include an identification of materials deposited inside a cement void within the annulus.

14. The method of any one of examples 1-13, wherein the one or more cement attributes estimated by the artificial neural network a volumetric size of one or more cement voids located within the annulus.

15. The method of any one of examples 1-14, wherein the one or more cement attributes estimated by the artificial neural network include a position of a cement void within the annulus.

16. The method of any one of examples 1-15, wherein the one or more cement attributes include one or more properties of a water column located within the annulus.

17. The method of example 16, wherein the one or more water column properties include water column extent.

18. The method of example 16 or 17, wherein the one or more water column properties include water column position.

19. The method of any one of examples 1-18, in which the one or more cement attributes estimated by the artificial neural network include a plurality of cement attributes estimated by the artificial neural network based on a common gamma spectrum.

20. A method comprising:
receiving via an input interface radiation log data indicating measurements of a gamma ray response resulting from gamma ray irradiation of an annulus of a borehole that extends through a formation, the annulus containing cured annulus cement, and the annulus being located radially between the formation and a casing that lines the borehole;
in an automated operation performed using an analyzer comprising a plurality of computer processor devices connected together in an artificial neural network, estimating one or more cement attributes indicative of quality of the annulus cement by performance of an automated estimation operation based at least in part on the radiation log data; and
providing an evaluation output indicating respective estimated values for the one or more cement attributes.

21. The method of example 20, further including the additional feature(s) of any one of examples 1-19.

22. A system comprising:
an input interface configured to receive radiation log data indicating measurements of a gamma ray response resulting from gamma ray irradiation of an annulus of a borehole that extends through a formation, the annulus containing cured annulus cement, and the annulus being located radially between the formation and a casing that lines the borehole; and
an analyzer comprising a plurality of computer processor devices connected together in an artificial neural network configured to estimate one or more cement attributes indicative of quality of the annulus cement by performance of an automated estimation operation based at least in part on the radiation log data, and to provide an evaluation output indicating respective estimated values for the one or more cement attributes.

23. The system of example 22, further being configured to perform the respective operation(s) of any one of examples 2-19.

Although specific examples have been illustrated and described herein, it will be appreciated by those of ordinary skill in the art that any arrangement that is calculated to achieve the same purpose may be substituted for the specific examples shown. Various examples use permutations and/or combinations of examples described herein. It is to be understood that the above description is intended to be illustrative, and not restrictive, and that the phraseology or terminology employed herein is for the purpose of description. Combinations of the above examples and other examples will be apparent to those of skill in the art upon studying the above description.

What is claimed is:

1. A method comprising:
using a radiation source carried by a downhole tool positioned within a borehole extending through a formation, causing gamma ray irradiation of an annulus that contains set cement and that is located between the formation and a casing lining the borehole;
measuring a gamma ray response resulting from the gamma ray irradiation of the annulus by use of a detector carried by the down hole tool, thereby to obtain radiation log data comprising gamma spectrum information of the annulus cement;
in an automated operation that is based at least in part on the radiation log data and that is performed using an artificial neural network configured therefor, estimating one or more cement attributes indicative of quality of the annulus cement; and
providing an evaluation output indicating respective estimated values for the one or more cement attributes.

2. The method of claim 1, further comprising the prior operation of training the artificial neural network by feeding to the artificial neural network training data pertaining to multiple example boreholes, the training data for each example borehole comprising respective gamma spectrum information and respective known values for the corresponding one or more cement attributes.

3. The method of claim 2, wherein the training data comprises experimental data obtained from respective borehole installations.

4. The method of claim 3, wherein the training data comprises simulation data obtained based on respective borehole simulations.

5. The method of claim 4, further comprising the prior operation of generating the simulation data for a set of example boreholes by performing operations comprising:
selecting from a set of borehole parameters a variable parameter whose value is to vary between different example boreholes in the set;
for each example borehole in the set, assigning a different respective value for the variable parameter;
fixing across the set of example boreholes common respective values for a remainder of the set of borehole parameters, so that the different example boreholes in the set differ only with respect to the variable parameter; and
deriving separate simulated gamma spectrum information for each example borehole in the set.

6. The method of claim 5, wherein the simulation data comprises gamma spectrum information for a plurality of different sets of example boreholes generated based on varying a single one of the set of borehole parameters, with a different borehole parameter selected as the variable parameter in generating the gamma spectrum information for the different sets.

7. The method of claim 1, further comprising providing as input to the artificial neural network one or more known parameters of the borehole.

8. The method of claim 7, wherein the one or more known parameters of the borehole comprises a cement density of the annulus cement.

9. The method of claim 7, wherein the one or more known parameters of the borehole comprises at least one geometry profile parameter indicating a physical configuration of at least one borehole element selected from the group comprising the casing and the annulus.

10. The method of claim 7, wherein the one or more known parameters of the borehole comprises an elemental composition parameter pertaining to composition of the annulus cement.

11. The method of claim 1, wherein the one or more cement attributes estimated by the artificial neural network comprises an identification of materials deposited inside a cement void within the annulus.

12. The method of claim 1, wherein the one or more cement attributes estimated by the artificial neural network comprises a volumetric size of one or more cement voids located within the annulus.

13. The method of claim 1, wherein the one or more cement attributes estimated by the artificial neural network comprises a position of a cement void within the annulus.

14. The method of claim 1, wherein the one or more cement attributes comprises one or more properties of a water column located within the annulus.

15. The method of claim 14, wherein the one or more water column properties are selected from the group consisting of: water column extent and water column position.

16. The method of claim 1 wherein the one or more cement attributes estimated by the artificial neural network comprises a plurality of cement attributes estimated by the artificial neural network based on a common gamma spectrum.

17. A system comprising:
an input interface configured to receive radiation log data indicating measurements of a gamma ray response resulting from gamma ray irradiation of an annulus of a borehole that extends through a formation, the annulus containing cured annulus cement, and the annulus being located radially between the formation and a casing that lines the borehole; and
an analyzer comprising a plurality of computer processor devices connected together in an artificial neural network configured to:
estimate one or more cement attributes indicative of quality of the annulus cement by performance of an automated estimation operation based at least in part on the radiation log data, and
provide an evaluation output indicating respective estimated values for the one or more cement attributes.

18. The system of claim 17, wherein the system further comprises a logging tool configured for positioning downhole within the borehole, the logging tool comprising:
a radiation source configured for causing gamma ray irradiation of the annulus; and
a detector configured for measuring the gamma ray response resulting from gamma ray irradiation of the annulus, thereby to know obtain the radiation log data.

19. The system of claim 17, wherein the analyzer is configured such that the one or more cement attributes comprise an identification of materials deposited inside a cement void within the annulus.

20. The system of claim 17, wherein the analyzer is configured such that the one or more cement attributes estimated by the artificial neural network comprises a position of a cement void within the annulus.
